(19) United States
(12) Patent Application Publication
(10) Pub. No.: US 2017/0205724 A1
(43) Pub. Date: Jul. 20, 2017

(54) ELECTROSTATIC INK COMPOSITIONS

(71) Applicant: Hewlett-Packard Indigo B.V., Amstelveen (NL)

(72) Inventors: Yaron Grinwald, Meitar (IL); Rada Nuchimov, Nes Ziona (IL); Gil Bar-Haim, Holon (IL)

(21) Appl. No.: 15/324,940

(22) PCT Filed: Jul. 18, 2014
(86) PCT No.: PCT/EP2014/065562

§ 371 Date: Jan. 9, 2017

(51) Int. Cl. G03G 9/135; G03G 9/08; G03G 9/12

(52) U.S. Cl. CPC G03G 9/1355; G03G 9/122; G03G 9/0804

(57) ABSTRACT

There is provided an electrostatic ink composition comprising chargeable particles comprising a resin and a conductive pigment; a charge director comprising a sulfosuccinate salt of the general formula MAn, wherein M is a metal, n is the valence of M, and A is an ion of the general formula [R¹—O—C(O)CH₂CH(SO₃)C(O)—O—R²] wherein each of R¹ and R² is an a Ikyl group; and a dispersant being or comprising a succinimide linked to a basic group. A method of manufacturing an electrostatic ink composition and a print medium are also described.

### BACKGROUND

Electrostatic printing processes typically involve creating an image on a photoconductive surface, applying an ink having charged particles to the photoconductive surface, such that they selectively bind to the image, and then transferring the charged particles in the form of the image to a print substrate.

The photoconductive surface is typically on a cylinder and is often termed a photo imaging plate (PIP). The photoconductive surface is selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, more commonly, by being first transferred to an intermediate transfer member, which can be a soft swelling blanket, and then to the print substrate. Variations of this method utilize different ways for forming the electrostatic latent image on a photoreceptor or on a dielectric material.

### BRIEF DESCRIPTION OF THE FIGURES

FIG. 1 shows tests on an example of an electroctrostatic ink composition described herein, in particular that low field conductivity (x axis, denoted ‘LF’, in units pmho) increases with increased amount of a sulfosuccinate charge director (y axis, in units of mg of charge director per gram of solids of the ink composition, i.e. mg/g), in the presence of an example dispersant having a succinimide linked to a basic group, namely J560 (see Examples for more details).

FIG. 2 shows the charging profile where the particle conductivity is saturated at ˜60 pmho low field conductivity when an example of an electrostatic ink composition is charged with a sulfosuccinate charge director, SCD, in the presence of a dispersant having a succinimide linked to a basic group, namely J560 (see Examples for more details).

FIG. 3 shows the charging profile where the rate of increase of low field conductivity with an increase in the amount of a sulfosuccinate charge director, SCD, is four times higher than that using a soy lecithin-based charge director, NCD.

FIG. 4 shows the overall charging profile with particle conductivity to low field conductivity of electrostatic ink composition containing a sulfosuccinate charge director and a succinimide linked to a basic group, compared to an electrostatic ink composition containing a soy lecithin-based charge director and a succinimide linked to a basic group.

### DETAILED DESCRIPTION

Before the electrostatic ink compositions and related aspects are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “liquid carrier”, “carrier liquid,” “carrier,” or “carrier vehicle” refers to the fluid in which the polymers, particles, colorant, charge directors and other additives can be dispersed to form a liquid electrostatic ink or electrophotographic ink. Such carrier liquids and vehicle components are known in the art. Typical carrier liquids can include a mixture of a variety of different agents, such as surfactants, co-solvents, viscosity modifiers, and/or other possible ingredients.

As used herein, “electrostatic ink composition” generally refers to an ink composition that is typically suitable for use in an electrostatic printing process, sometimes termed an electrophotographic printing process. The electrostatic ink composition may include chargeable particles of the resin and the pigment dispersed in a liquid carrier, which may be as described herein.

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly, or indirectly via an intermediate transfer member, to a print substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g. an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

In a first aspect, there is provided an electrostatic ink composition. The an electrostatic ink composition may comprise:
a) chargeable particles comprising a resin and a conductive pigment;
b) a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²]⁻ (I)
wherein each of R¹ and R² is an alkyl group; and
c) a dispersant being or comprising a succinimide linked to a basic group.

In a second aspect, there is provided a method of manufacturing an electrostatic ink composition according to the first aspect. The method may comprise combining:
a) a resin;
b) a conductive pigment;
c) a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²] (I)
wherein each of R¹ and R² is an alkyl group; and
d) a dispersant being or comprising a succinimide linked to a basic group, the electrostatic ink composition comprising chargeable particles comprising the resin and the conductive pigment.

In a third aspect, there is provided a printed medium having printed thereon an electrostatic ink composition. The electrostatic ink composition may comprise:
a) a resin and a conductive pigment;
b) a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²]⁻ (I)
wherein each of R¹ and R² is an alkyl group; and
c) a dispersant being or comprising a succinimide linked to a basic group.

In liquid electrophotographic printing that involves use of a intermediate transfer member, the use of a sulfosuccinate salt charge director as described herein rather than a charge director based on soy lecithin has led, in some circumstances, to some charged particles of ink being retained on the intermediate transfer member, rather than making the second transfer onto the print substrate, which can lead to high background levels being observed on the print substrate. This has been observed to a greater extent in electrophotographic ink compositions in which the pigment is conductive.

The inventors have found that, mixing the conductive pigments with a dispersant including a succinimide linked to a basic group can result in an ink composition with more stable charging and partitioning, similar to those for ink compositions based using a soy lecithin-based charge director.

### Resin

The electrostatic ink composition includes chargeable particles comprising a resin, which may be a thermoplastic resin. A thermoplastic polymer is sometimes referred to as a thermoplastic resin. The resin may coat the conductive pigment, e.g. a conductive pigment, such that the particles include a core of conductive pigment, and have an outer layer of resin thereon. The outer layer of resin may coat the conductive pigment partially or completely.

The resin typically includes a polymer. The resin can include, but is not limited to, a thermoplastic polymer. In some examples, the polymer of the resin may be selected from ethylene acrylic acid copolymers; ethylene methacrylic acid copolymers; ethylene vinyl acetate copolymers; copolymers of ethylene (e.g. 80 wt % to 99.9 wt %), and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt % to about 25 wt % of the copolymer, in some examples from 10 wt % to about 20 wt % of the copolymer.

The resin may comprise two different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise two different polymers having acidic side groups: a first polymer that is a copolymer of ethylene (e.g. 92 to 85 wt %, in some examples about 89 wt %) and acrylic or methacrylic acid (e.g. 8 to 15 wt %, in some examples about 11 wt %) having a melt flow rate of 80 to 110 g/10 minutes and a second polymer that is a co-polymer of ethylene (e.g. about 80 to 92 wt %, in some examples about 85 wt %) and acrylic acid (e.g. about 18 to 12 wt %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt % to about 16 wt % of the copolymer, in some examples 10 wt % to 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt % to about 30 wt % of the copolymer, in some examples from 14 wt % to about 20 wt % of the copolymer, in some examples from 16 wt % to about 20 wt % of the copolymer in some examples from 17 wt % to 19 wt % of the copolymer.

In an example, the resin constitutes about 5 to 90° A), in some examples about 5 to 80%, by weight of the solids of the electrostatic ink composition. In another example, the resin constitutes about 10 to 60% by weight of the solids of the electrostatic ink composition. In another example, the resin constitutes about 15 to 40% by weight of the solids of the electrostatic ink composition. In another example, the resin constitutes about 60 to 95% by weight, in some examples from 80 to 90% by weight, of the solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the co-polymer, in some examples 5 to 40% by weight, in some examples 5 to 20% by weight of the copolymer, in some examples 5 to 15% by weight of the copolymer. The second monomer may constitute 1 to 50% by weight of the co-polymer, in some examples 5 to 40% by weight of the co-polymer, in some examples 5 to 20% by weight of the co-polymer, in some examples 5 to 15% by weight of the copolymer. In an example, the first monomer constitutes 5 to 40% by weight of the co-polymer, the second monomer constitutes 5 to 40% by weight of the co-polymer, and with the third monomer constituting the remaining weight of the copolymer. In an example, the first monomer constitutes 5 to 15% by weight of the co-polymer, the second monomer constitutes 5 to 15% by weight of the co-polymer, with the third monomer constituting the remaining weight of the copolymer. In an example, the first monomer constitutes 8 to 12% by weight of the co-polymer, the second monomer constitutes 8 to 12% by weight of the co-polymer, with the third monomer constituting the remaining weight of the copolymer. In an example, the first monomer constitutes about 10% by weight of the co-polymer, the second monomer constitutes about 10% by weight of the co-polymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aaclyn 201, Aclyn 246, Aclyn 285, and Aclyn 295), and the Lotader family of toners (e.g. Lotader 2210, Lotader, 3430, and Lotader 8200 (sold by Arkema)).

### Conductive Pigment

The conductive pigment, in the present application, indicates an electrically conductive pigment. The conductive pigment may comprise a metal. The metal may be a metal in elemental form or an alloy of two or more metals. The conductive pigment may comprise a metal selected from aluminium, tin, a transition metal, and alloys of any one or more thereof. The metal may be aluminium. The transition metal may be selected from, for example, zinc, copper, silver, gold, nickel, palladium, platinum, and iron. Alloys that may be used include, but are not limited to, brass, bronze, steel and chromium.

The conductive pigment, in any of the aspects herein, may have any three-dimensional shape. In some examples, the conductive pigment is in the form selected from a flake, a sphere, a rod, or approximations thereof. In the present application, a flake may be a shape with a first dimension, which may be termed a thickness, less than the other two dimensions. In some examples, the flake has a thickness of at least 0.01 μm, in some examples a thickness of at least 0.05 μm, in some examples a thickness of at least 0.05 μm, in some examples a thickness of at least 0.1 μm, in some examples a thickness of at least 0.15 μm, in some examples a thickness of at least 0.18 μm. In some examples, the flake has a thickness of 1 μm or less, in some examples a thickness of 0.8 μm or less, in some examples a thickness of 0.5 μm or less, in some examples a thickness of 0.4 μm or less, in some examples a thickness of 0.3 μm or less.

In some examples, the flake has a diameter, measured in a direction perpendicular to the thickness, of at least 1 μm, in some examples a diameter of at least 2 μm, in some examples a diameter of at least 3 μm, in some examples a diameter of at least 4 μm, in some examples a diameter of at least 5 μm, in some examples a diameter of at least 6 μm, in some examples a diameter of at least 7 μm, in some examples a diameter of at least 8 μm. In some examples, the flake has a diameter, measured in a direction perpendicular to the thickness, of 50 μm or less, in some examples a diameter of 40 μm or less, in some examples a diameter of 30 μm or less, in some examples a diameter of 20 μm or less, in some examples a diameter of 15 μm or less.

In some examples, the conductive pigment has an aspect ratio of a diameter (measured in a direction perpendicular to the thickness) to its thickness of n:1, where n is at least 2, in some examples at least 5, in some examples at least 10, in some examples at least 20, in some examples at least 30, in some examples at least 35. In some examples, the conductive pigment has an aspect ratio of a diameter (measured in a direction perpendicular to the thickness) to its thickness of n:1, where n is 100 or less, in some examples n is 80 or less, in some examples n is 70 or less, in some examples n is 60 or less, in some examples n is 50 or less.

In some examples, the conductive pigments, excluding any dispersant thereon, constitute 15% or less by weight of the solids in the electrostatic ink composition of the first aspect or the electrostatic ink composition produced in the second aspect. In some examples, the conductive pigments, excluding any dispersant thereon, constitute 12% or less by weight, in some examples 10% or less by weight, in some examples 8% or less by weight of the solids in the electrostatic ink composition of the first aspect or the electrostatic ink composition produced in the second aspect. In some examples, the conductive pigments, excluding any dispersant thereon, constitute 1% or more by weight, in some examples 2% or more by weight, in some examples 4% or more by weight, in some examples 6% or more by weight by weight, in some examples 8% or more by weight, of the solids in the electrostatic ink composition of the first aspect or the electrostatic ink composition produced in the second aspect.

### Charge Director

The electrostatic ink composition includes a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²]⁻ (I)

wherein each of R¹ and R² is an alkyl group. The charge director may be as described in WO2007130069, which is incorporation herein by reference in its entirety.

The charge director may be added in order to impart and/or maintain sufficient electrostatic charge on the ink particles, which may be particles comprising the pigment, the resin and the dispersant.

As described in WO2007130069, the sulfosuccinate salt of the general formula MAn is an example of a micelle forming salt. The charge director may be substantially free or free of an acid of the general formula HA, where A is as described above. The charge director may include micelles of said sulfosuccinate salt enclosing at least some of the nanoparticles. The charge director may include at least some nanoparticles having a size of 200 nm or less, and/or in some examples 2 nm or more.

The charge director may further comprise a simple salt. As described in WO2007130069, simple salts are salts that do not form micelles by themselves, although they may form a core for micelles with a micelle forming salt. The ions constructing the simple salts are all hydrophilic. The simple salt may include a cation selected from the group consisting of Mg, Ca, Ba, NH4, tert-butyl ammonium, Li+, and Al+3, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F—, ClO₄—, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)3, LiClO₄ and LiBF₄, or any sub-group thereof. The charge director may further include basic barium petronate (BBP).

In the formula [R₁—O—C(O)CH₂CH(SO₃⁻)C(O)—O—R₂], in some examples each of R₁ and R₂ is an aliphatic alkyl group. In some examples, each of R₁ and R₂ independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇. In some examples, M is Na, K, Cs, Ca, or Ba. The formula [R₁—O—C(O)CH₂CH(SO₃⁻)C(O)—O—R₂] and/or the formula MAn may be as defined in any part of WO2007130069.

The charge director may further include one of, some of or all of (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20%, in some examples 0.01% to 20% by weight, in some examples 0.01 to 10% by weight, in some examples 0.01% to 1% by weight of the solids of an electrostatic ink composition. In some examples, the charge director constitutes about 0.001% to 0.15% by weight of the solids of the electrostatic ink composition, in some examples 0.001% to 0.15%, in some examples 0.001% to 0.02% by weight of the solids of an electrostatic ink composition, in some examples 0.1% to 2% by weight of the solids of the electrostatic ink composition, in some examples 0.2% to 1.5% by weight of the solids of the electrostatic ink composition in some examples 0.1% to 1% by weight of the solids of the electrostatic ink composition, in some examples 0.2% to 0.8% by weight of the solids of the electrostatic ink composition. In some examples, the charge director is present in an amount of at least 1 mg of charge director per gram of solids of the electrostatic ink composition (which will be abbreviated to mg/g), in some examples at least 2 mg/g, in some examples at least 3 mg/g, in some examples at least 4 mg/g, in some examples at least 5 mg/g. In some examples, the moderate acid is present in the amounts stated above, and the charge director is present in an amount of from 1 mg to 50 mg of charge director per gram of solids of the electrostatic ink composition (which will be abbreviated to mg/g), in some examples from 1 mg/g to 25 mg/g, in some examples from 1 mg/g to 20 mg/g, in some examples from 1 mg/g to 15 mg/g, in some examples from 1 mg/g to 10 mg/g, in some examples from 3 mg/g to 20 mg/g, in some examples from 3 mg/g to 15 mg/g, in some examples from 10 mg/g to 15 mg/g, in some examples from 5 mg/g to 10 mg/g.

The electrostatic ink composition may further include a charge adjuvant. A charge adjuvant may promote charging of the particles when a charge director is present. The method as described here may involve adding a charge adjuvant at any stage. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminum di- or tristearate. The charge adjuvant may be present in an amount of about 0.1 to 5% by weight, in some examples about 0.1 to 1% by weight, in some examples about 0.3 to 0.8% by weight of the solids of the electrostatic ink composition, in some examples about 1 wt % to 3 wt % of the solids of the electrostatic ink composition, in some examples about 1.5 wt % to 2.5 wt % of the solids of the electrostatic ink composition.

In some examples, the electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al3+. The fatty acid anion may be selected from a saturated or unsaturated fatty acid anion. The fatty acid anion may be selected from a C₈ to C₂₆ fatty acid anion, in some examples a C₁₄ to C₂₂ fatty acid anion, in some examples a C₁₆ to C₂₀ fatty acid anion, in some examples a C₁₇, C₁₈ or C₁₉ fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of multivalent cation and a fatty acid anion, may be present in an amount of 0.1 wt % to 5 wt % of the solids of the electrostatic ink composition, in some examples in an amount of 0.1 wt % to 2 wt % of the solids of the electrostatic ink composition, in some examples in an amount of 0.1 wt % to 2 wt % of the solids of the electrostatic ink composition, in some examples in an amount of 0.3 wt % to 1.5 wt % of the solids of the electrostatic ink composition, in some examples about 0.5 wt % to 1.2 wt % of the solids of the electrostatic ink composition, in some examples about 0.8 wt % to 1 wt % of the solids of the electrostatic ink composition, in some examples about 1 wt % to 3 wt % of the solids of the electrostatic ink composition, in some examples about 1.5 wt % to 2.5 wt % of the solids of the electrostatic ink composition.

### Dispersant

The electrostatic ink composition includes a dispersant being or comprising a succinimide linked to a basic group.

Dispersants can be two-component structures, comprising a head group, which can provide strong adsorption onto the conductive pigment surface and a tail group. In some examples, the dispersant is a dispersant having a basic head group, for example an amine, capable of being absorbed on to the surface of the conductive pigment and a succinimide attached to the basic head group.

The basic head group may comprise an amine group, which may be selected from a primary amine group, a secondary amine group and a tertiary amine group. The basic head group may comprise a plurality of amine groups, which may each independently be selected from a primary amine group, a secondary amine group and a tertiary amine group.

In some examples, each dispersant molecule comprises a multi amine head group or a single amine head group, in some examples each polymeric dispersant molecular comprises a multi amine head group. In some examples, the dispersant comprises polyolefin amide alkeneamine.

In some examples, each dispersant molecule comprises one polymer chain or a plurality of polymer chains. In some examples, each dispersant molecule comprises one polymer chain having a single amine head group. In some examples, each polymeric dispersant molecule comprises one polymer chain having a plurality of amine head groups. In some examples, the polymer chain has acidic side groups.

The dispersant comprises a succinimide. The succinimide is linked, e.g. via a hydrocarbon-containing linker group, to the basic group, for example an amine group. In some examples, the dispersant comprises a polyisobutylene succinimide having a head group comprising an amine.

In some examples, the dispersant is of formula (I)

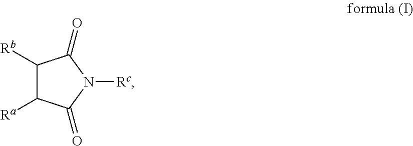

wherein R^{a}, R^{b} and R^{c} are selected from an amine-containing head group, a hydrocarbon tail group and hydrogen,
wherein at least one of R^{a}, R^{b} and R^{c} comprises a hydrocarbon tail group, at least one of R^{a}, R^{b} and R^{c} comprises an amine-containing head group. In some examples, R^{a} and R^{b} are selected from a hydrocarbon tail group and hydrogen, with at least one of R^{a} and R^{b} comprising a hydrocarbon tail group, and R^{c} comprises an amine-containing head group. The hydrocarbon tail group may comprise or be a hydrocarbon group, which may be branched or straight chain and may be unsubstituted. The hydrocarbon tail group may comprise or be a hydrocarbon group containing a polyalkylene, which may be selected from a polyethylene, polypropylene, polybutylene. In some examples, the hydrocarbon tail group may contain a polyisobutylene. The hydrocarbon tail group may contain from 10 to 100 carbons, in some examples from 10 to 50 carbons, in some examples from 10 to 30 carbons. The hydrocarbon tail group may be of the formula (II)

P-L- formula (II),

wherein P is or comprises polyisobutylene and L is selected from a single bond, (CH₂)ₙ, wherein n is from 0 to 5, in some examples 1 to 5, —O— and —NH—. In some examples, the amine-containing head group comprises or is a hydrocarbon group having an amine group attached to one of the carbons of the hydrocarbon group. In some examples, the amine-containing head group is of the formula (III)

(CH₂)ₘ[(CH₂)ₒNH(CH₂)ₚ]_{q}(CH₂)ᵣ—NH₂ formula (III),

wherein m is at least 1, in some examples 1 to 5, q is 0 to 10, o is 0, 1 or 2, p is 1 or 2, r is 0 to 10; in some examples, m is 1, o is 1, p is 1 and q is from 0 to 10, in some examples from 1 to 5, and in some examples r is 1 to 5; in some examples m is 1, q is 0 to 10, in some examples 1 to 10, in some examples 1 to 5, o is 1, p is 1, r is 1.

In some examples, the dispersant is of formula (I), wherein R^{a} is of formula (II), R^{b} is H and R^{c} is of formula (III). In some examples, the dispersant is of formula (I), wherein R^{a} is of formula (II), wherein L is —CH₂—, R^{b} is H and R^{c} is of formula (III), wherein m is 1, q is 0 to 10, in some examples 1 to 10, in some examples 1 to 5, o is 1, p is 1 and r is 1. In some examples, the dispersant is or comprises polyisobutylene succimide polyethylene amine non ionic dispersant. In some examples, the dispersant is or comprises Solsperse® J560 and/or Lubrizol® 6406. In some examples, the dispersant is or comprises Solsperse® J560.

In some examples, the dispersant is or comprises an alkyl succimide amido salt, in some examples a polyisobutylene succimide amido salt, in some examples an alkyl succimide amido amino salt, in some examples polyisobutylene succimide amido ammonium salt, and in some examples the polyisobutylene succimide amido ammonium salt comprises a plurality of amido and/or ammonium groups, and in some examples the polyisobutylene succimide amido ammonium salt comprises at least one branched group, e.g. a branched alkyl group, and a plurality of amido and/or ammonium groups, which may be attached, directly or indirectly to the at least one branched group. In some examples, the dispersant is or comprises OS 13309, which is available from Lubrizol Corporation.

In some examples, the dispersant is a basic dispersant having a total base number (TBN) of at least 5 mgKOH/gr material, in some examples a TBN of at least 10 mgKOH/gr material, in some examples a TBN of at least 20 mgKOH/gr material, in some examples a TBN of at least 30 mgKOH/gr material, in some examples from 5 mgKOH/gr material to 150 mgKOH/gr material, in some examples from 5 mgKOH/gr material to 150 mgKOH/gr material. In some examples, the dispersant is a basic dispersant having a total base number (TBN) of from 30 mgKOH/gr material to 60 mgKOH/gr material, in some examples from 35 mgKOH/gr material to 55 mgKOH/gr material, in some examples about 45 mgKOH/gr material.

Total base number (TBN), sometimes simply referred to as base number, may be determined using standard techniques, including, those laid out in ASTM Designation D4739-08, such as Test Method D2896, Test Method D4739, and ASTM Designation D974-08, with Test Method D2896 being used if any discrepancy is shown between test methods, and unless otherwise stated, the test method(s) will be the most recently published at the time of filing this patent application. “mgKOH/gr material” indicates “mgKOH per gram of dispersant”. The measurement of TBN of the dispersant can either be on the pure dispersant, or a dispersant in a hydrocarbon liquid, such 60 wt % dispersant in white spirit, e.g. dearomatized white spirit, and then adjusted as if it had been measured on the pure dispersant.

The dispersant comprises a succinimide, which may be as described above, and, in some examples, the succinimide has a molecular weight (MW) of from 500 Daltons to 10,000 Daltons, in some examples a MW of from 1000 to 6,000 Daltons, in some examples a MW of from 1000 to 6,000 Daltons, in some examples a MW of from 1000 to 5000 Daltons, in some examples a MW of from 2000 to 4000 Daltons, in some examples a MW of about 3000 Daltons.

The % AOWP (the percentage agent on the weight of pigment) is the number of grams of dispersant per 100 g of pigment. In some examples, the % AOWP of the dispersion is from 0.1% to 70%, in some examples from 0.1% to 50%, in some examples from 0.1% to 30%, in some examples from 0.1% to 10%, in some examples 0.5% to 8%

The dispersant may constitute from 0.1 wt % to 50 wt % of the solids of the electrostatic ink composition, in some examples 0.5 wt % to 30 wt % of the solids of the electrostatic ink composition, in some examples 1 wt % to 25 wt % of the solids of the electrostatic ink composition, in some examples 1 wt % to 20 wt % of the solids of the electrostatic ink composition, in some examples 5 wt % to 15 wt % of the solids of the electrostatic ink composition, in some examples 8 wt % to 12 wt % of the solids of the electrostatic ink composition, in some examples about 10 wt % of the solids of the electrostatic ink composition.

The coating of the dispersant on the conductive pigment may be produced using any suitable method. The coating of the dispersant on the conductive pigment may be produced by contacting conductive pigment not having a coating of dispersant thereon with the dispersant, which, in some examples, is in a liquid medium. In some examples, the conductive pigment having a coating of dispersant thereon is produced by or producible by contacting a conductive pigment not having a coating of dispersant thereon with a liquid medium containing the dispersant until a coating of the dispersant is formed on the conductive pigment. The liquid medium may contain at least 0.5% by weight of the dispersant, before contacting with the conductive pigment. The liquid medium may contain at least 1% by weight, in some examples at least 1.5% by weight, in some examples at least 2% by weight, in some examples at least 2.5% by weight, of the dispersant before contacting with the conductive pigment. The liquid medium may contain 20% or less by weight of the dispersant, before contacting with the conductive pigment. The liquid medium may contain 15% or less by weight of the dispersant, before contacting with the conductive pigment. The liquid medium may contain from 0.5 to 10% by weight of the dispersant, before contacting with the conductive pigment, in some examples from 1 to 5% by weight. Further dispersant may be added if desired, on mixing the conductive pigment with the resin, e.g. during the grinding of the resin with the conductive pigment (that has been pre-treated with a quantity of the dispersant), and, in some examples, before the charge director is added to the composition. After contacting of the dispersant with the conductive pigment and during coating of the dispersant on the conductive pigment, the mixture or the solids content of the mixture may comprise at least 10 wt % conductive pigment, in some examples at least 20 wt % conductive pigment, in some examples from 10 to 50 wt % conductive pigment, in some examples 20 to 40 wt % conductive pigment, in some examples 25 to 35 wt % conductive pigment. In some examples, the liquid medium is of the same type as the liquid carrier. In some examples, the liquid medium comprises a hydrocarbon liquid.

In some examples, the weight:weight ratio of the charge director to the dispersant is from 1:1 to 1:1000, for example from 1:10 to 1:500, for example from 1:10 to 1:200, for example from 1:10 to 1:150, for example from 1:30 to 1:120, for example from 1:40 to 1:110, for example from 1:60 to 1:100.

In some examples, the weight:weight ratio of the charge director to the dispersant is from 1:2 to 1:30, for example from 1:3 to 1:20, for example from 1:4 to 1:20, for example from 1:5 to 1:20, for example from 1:7 to 1:20, for example from 1:8 to 1:20, for example from 1:10 to 1:20, for example from 1:12 to 1:20, for example from 1:15 to 1:20, for example from 1:3 to 1:15, for example from 1:3 to 1:10, for example from 1:3 to 1:8, for example from 1:3 to 1:6, for example from 1:3 to 1:6, for example from 1:4 to 1:15, for example from 1:5 to 1:12, for example from 1:5 to 1:10, for example from 1:6 to 1:8.

In some examples, the charge director is present in an amount of from 3 mg/g to 20 mg/g, in some examples from 3 mg/g to 15 mg/g, in some examples from 10 mg/g to 15 mg/g, in some examples from 5 mg/g to 10 mg/g, and the weight:weight ratio of the charge director to the dispersant is from 1:1 to 1:1000, for example from 1:10 to 1:500, for example from 1:10 to 1:200, for example from 1:10 to 1:150, for example from 1:30 to 1:120, for example from 1:40 to 1:110, for example from 1:60 to 1:100.

In some examples, the charge director is present in an amount of from 3 mg/g to 15 mg/g, in some examples from 10 mg/g to 15 mg/g, and the weight:weight ratio of the charge director to the dispersant is from 1:10 to 1:150, for example from 1:30 to 1:120, for example from 1:40 to 1:110, for example from 1:60 to 1:100.

In some examples, the charge director is present in an amount of from 3 mg/g to 15 mg/g, in some examples from 10 mg/g to 15 mg/g, and the weight:weight ratio of the charge director to the dispersant is from 1:60 to 1:100.

When calculating the weight:weight ratio of the charge director to the dispersant, the weight of the charge director is taken as the weight of the sulfosuccinate salt according to the present disclosure, plus any other component(s) of the charge directors that may be present (e.g. the simple salt, as described above).

### Liquid Carrier

The electrostatic ink composition may further include a liquid carrier. In some examples, the mixing of the pigment and the dispersant is carried out in a liquid carrier (i.e. the pigment and dispersant are mixed in a liquid carrier) and/or the grinding of the dispersion in the resin is carried out in a liquid carrier (i.e. the pigment dispersion and the resin is ground in the presence of a liquid carrier). In some examples, in the electrostatic ink composition, particles including the resin, the conductive pigment and the dispersant may be dispersed in the liquid carrier. The liquid carrier can include or be a hydrocarbon, silicone oil, vegetable oil, etc. The liquid carrier can include, but is not limited to, an insulating, non-polar, non-aqueous liquid that can be used as a medium for toner particles, i.e. the chargeable particles including the resin and, in some examples, a pigment. The liquid carrier can include compounds that have a resistivity in excess of about 10⁹ ohm-cm. The liquid carrier may have a dielectric constant below about 5, in some examples below about 3. The liquid carrier can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the liquid carriers include, but are not limited to, aliphatic hydrocarbons, isoparaffinic compounds, paraffinic compounds, dearomatized hydrocarbon compounds, and the like. In particular, the liquid carriers can include, but are not limited to, IsoparG™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

The liquid carrier can constitute about 20% to 99.5% by weight of the electrostatic ink composition, in some examples 50% to 99.5% by weight of the electrostatic ink composition. The liquid carrier may constitute about 40 to 90% by weight of the electrostatic ink composition. The liquid carrier may constitute about 60% to 80% by weight of the electrostatic ink composition. The liquid carrier may constitute about 90% to 99.5% by weight of the electrostatic ink composition, in some examples 95% to 99% by weight of the electrostatic ink composition.

The electrostatic ink composition, when printed on a print substrate, may be substantially free from liquid carrier. In an electrostatic printing process and/or afterwards, the liquid carrier may be removed, e.g. by an electrophoresis processes during printing and/or evaporation, such that substantially just solids are transferred to the print substrate. Substantially free from liquid carrier may indicate that the ink printed on the print substrate contains less than 5 wt % liquid carrier, in some examples, less than 2 wt % liquid carrier, in some examples less than 1 wt % liquid carrier, in some examples less than 0.5 wt % liquid carrier. In some examples, the electrostatic ink composition printed on the print substrate is free from liquid carrier.

Further provided is an electrostatic ink composition comprising:
a) chargeable particles comprising a resin and a conductive pigment;
b) a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²]⁻ (I)
wherein each of R¹ and R² is an alkyl group;
c) a dispersant being or comprising a succinimide linked to a basic group; and
d) a liquid carrier, wherein the chargeable particles are dispersed in the liquid carrier, and wherein the conductive pigment has a coating of dispersant thereon.

### Other Additives

The electrostatic ink composition may include an additive or a plurality of additives. The additive or plurality of additives may be added at any stage of the method. The additive or plurality of additives may be selected from a wax, a surfactant, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket.

### Method

Also provided is a method of manufacturing an electrostatic ink composition according to the first aspect, comprising combining:
a) a resin;
b) a conductive pigment;
c) a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²] (I)
wherein each of R¹ and R² is an alkyl group; and
d) a dispersant being or comprising a succinimide linked to a basic group, the electrostatic ink composition comprising chargeable particles comprising the resin and the conductive pigment.

In some examples, the method comprises providing a resin and a conductive pigment having a coating of dispersant thereon, and grinding the resin and conductive pigment in a mill, for example a ball mill, and wherein, in some examples, a liquid carrier is added before, during or after the grinding.

In some examples, the liquid carrier is present during the grinding of the resin and conductive pigment in a mill; and in some examples, the liquid carrier constitutes 10 to 99% by weight of the composition being ground in the mill, in some examples 30 to 99% by weight of the composition being ground in the mill, in some examples 50 to 95% by weight of the composition being ground in the mill, in some examples 70 to 90% by weight of the composition being ground in the mill. The grinding in a mill may be carried out by rotating the mixture such that the RPM of the rotations is at least 100 RPM, in some examples at least 200 RPM, in some examples at least 250 RPM, in some examples from 100 RPM to 500 RPM, in some examples from 200 RPM to 300 RPM, in some examples about 250 RPM; and in some examples the grinding may be carried out for a period of at least 1 hour, in some examples 2 hours, in some examples 3 hours, in some examples 4 hours. The temperature during grinding may be at least 20° C., in some examples at least 25° C., in some examples at least 30° C. A suitable grinding mill is a ball mill or attritor. A commercially available attritor is available from Union Process, such as a Union S1—attritor.

In some examples, the method comprises providing a resin and a conductive pigment having a coating of dispersant thereon, then mixing the resin and the conductive pigment having a coating of dispersant thereon in a continuous mixer to form a compounded mixture, then adding the liquid carrier to the compounded mixture to form the electrostatic ink composition. The compounded mixture may contain particles comprising the resin and the conductive pigment coated by the dispersant; the resin in the particles may partially or fully encapsulate the conductive pigments. The liquid carrier may be added in the same continuous mixer, e.g. extruder, in which the resin and conductive pigment have previously been mixed. In an alternative example, the compounded mixture may be removed from the continuous mixer in which the resin and conductive pigment have been mixed, and then the liquid carrier added, for example in a mixing apparatus, which may be a continuous mixer or other type of mixing apparatus, such as a ball mill.

After addition of the liquid carrier, if present, the method may involve removing at least some particles above a predetermined size. The removing of the particle above a predetermined size may involve filtering the mixture comprising the liquid carrier, the resin and the conductive pigment. In some examples, the removing of the particle above a predetermined size may involve subjecting the mixture comprising a liquid carrier, the resin and the conductive pigment to a centrifugal process.

The continuous mixer may be an extruder. In some examples, the continuous mixer may be a twin-screw extruder.

The extruder may comprise one or more screws, in some examples two screws, such as in a twin-screw extruder. The one or more screws may rotate at a speed of at least 200 rpm, in some examples at least 400 rpm, in some example at least 600 rpm, in some examples at least 700 rpm, in some examples at least 800 rpm. The one or more screws may rotate at a speed of 1000 rpm or less, in some examples 900 rpm or less, in some examples 800 rpm or less, in some examples 700 rpm or less, in some examples 600 rpm or less, in some examples 500 rpm or less, in some examples 400 rpm or less, in some examples 300 rpm or less. The one or more screws may rotate at a speed of from 100 rpm to 500 rpm, in some examples from 200 rpm to 400 rpm, in some examples from 250 rpm to 300 rpm. In some examples, the extruder comprises at least two interlocking or intermeshing co-rotating screws. This arrangement of screws has been found to be particularly advantageous in being able to mix the conductive pigments and the resin to a high degree without damaging, at least to any significant effect, the conductive pigments, and forming particles of resin that encapsulate the conductive pigments. The amount of material, which may be the amount of solids excluding any liquid material, being extruded by the extruder per hour may be at least 1 kg, in some examples at least 2 kg, in some examples at least 3 kg. The amount of material, which may be the amount of solids excluding any liquid material, being extruded by the extruder per hour may be 10 kg or less, in some examples 7 kg or less, in some examples 5 kg or less, in some examples 4 kg or less, in some examples 4 kg or less, in some examples 3 kg or less. The amount of material, which may be the amount of solids excluding any liquid material, being extruded by the extruder per hour may be from 1 to 5 kg, in some examples 2 kg to 4 kg, in some examples 2.5 kg to 3.5 kg.

The mixing of the resin and conductive pigment in the continuous mixer may be carried out at a temperature of 80° C. or more, in some examples 90° C. or more, in some examples, 95° C. or more, in some examples 100° C. or more.

In some examples, the liquid carrier is added to the compounded mixture in the continuous mixer, in some examples after the resin and a conductive pigment having a coating of dispersant thereon have been mixed in the continuous mixer.

In some examples, the method of the second aspect comprises:
i) contacting the dispersant and the conductive pigment; and then
ii) mixing the conductive pigment having a coating of dispersant thereon with the resin;
wherein the charge director can be added before, during or after the contacting and mixing steps.

In some examples, the contacting the dispersant and the conductive pigment also involves contacting the dispersant and the conductive pigment with a liquid carrier.

In some examples, the contacting of the contacting the dispersant and the conductive pigment involves mixing the conductive pigment and the dispersant and then agitating the mixture, for example by a method involving one or more of shaking, high shear mixing and/or subjecting the mixture to ultrasound.

The high shear mixing may involve stirring the mixture, for example at a high speed, for example a speed of at least 1000 RPM, in some examples at least 5000 RPM, in some examples at least 10,000 RPM, in some examples at least 15,000 RPM, in some examples at least 20,000. The stirring may be carried out for a period of at least 30 minutes, in some examples at least 1 hour in some examples at least hour 30 minutes. In some examples, the stirring may be carried out at least 10,000 RPM for at least 30 minutes, in some examples at least 20,000 RPM for at least 1 hour.

Subjecting the mixture to ultrasound may involve subjecting the mixture to ultrasound for a period of at least 30 minutes, in some examples at least 60 minutes, in some examples at least 90 minutes.

The electrostatic ink composition produced by the method of the second aspect and/or the electrostatic ink composition of the first aspect may contain at least some particles having a particle size of 100 μm or less, in some examples a particle size of 50 μm or less, in some examples a particle size of 30 μm or less, in some examples a particle size of 20 μm or less, in some examples a particle size of 10 μm or less. In some examples, at least 90% by volume of the particles in the electrostatic ink composition produced by the method of the first aspect and/or the electrostatic ink composition of the second aspect have a particle size of 100 μm or less, in some examples a particle size of 50 μm or less, in some examples a particle size of 30 μm or less, in some examples a particle size of 20 μm or less. Particle size may be measured using any suitable technique, for example using a particle analyzer. Particle analyzers are commercially available, e.g. a Malvern Mastersizer 2000.

In the electrostatic ink composition produced by the method of the second aspect and/or the electrostatic ink composition of the first aspect may contain a charge adjuvant. The charge adjuvant may be added during any stage of the method, for example before, during or after the mixing, e.g. grinding, of the resin and conductive pigment with the liquid carrier. The charge adjuvant may comprise an aluminium salt. The charge adjuvant may comprise a fatty acid metal salt. In an example, the charge adjuvant may comprise a fatty acid aluminium salt. In an example, the charge adjuvant is or comprises an aluminium stearate, e.g. an aluminium di- or tri-stearate.

### Print Substrate and Printing Process

Also provided is a printed medium having printed thereon an electrostatic ink composition comprising:
a) a resin and a conductive pigment;
b) a charge director comprising a sulfosuccinate salt of the general formula MAn, wherein M is a metal, n is the valence of M, and A is an ion of the general formula (I):

[R¹—O—C(O)CH₂CH(SO₃)C(O)—O—R²]⁻ (I)
wherein each of R¹ and R² is an alkyl group; and
c) a dispersant being or comprising a succinimide linked to a basic group.

The print medium may be any suitable medium. The print medium may be any suitable medium capable of having an image printed thereon. The print medium may include a material selected from an organic or inorganic material. The material may include a natural polymeric material, e.g. cellulose. The material may include a synthetic polymeric material, e.g. a polymer formed from alkylene monomers, including, but not limited to, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), mixtures thereof. In an example, the print medium includes a cellulosic paper. In an example, the cellulosic paper is coated with a polymeric material, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The print medium is, in some examples, a cellulosic print medium such as paper. The cellulosic print medium is, in some examples, a coated cellulosic print. In some examples, a primer may be coated onto the print medium, before the electrostatic ink composition is printed onto the print substrate.

Also provided is a method of electrophotographic printing an electrostatic ink composition as described herein, for example as produced in accordance with the second aspect or in accordance with the first aspect, wherein the ink composition comprises particles comprising the resin, the conductive pigment, in some examples dispersed in a liquid carrier, the method comprising:
forming a latent electrostatic image on a surface;
contacting the surface with the electrostatic ink composition, such that at least some of the particles adhere to the surface to form a developed toner image on the surface, and transferring the toner image to a print medium, in some examples via an intermediate transfer member.

The surface on which the latent electrostatic image is formed may be on a rotating member, e.g. in the form of a cylinder. The surface on which the latent electrostatic image is formed may form part of a photo imaging plate (PIP). The contacting may involve passing the electrostatic composition between a stationary electrode and a rotating member, which may be a member having the surface having a latent electrostatic image thereon or a member in contact with the surface having a latent electrostatic image thereon. A voltage is applied between the stationary electrode and the rotating member, such that the particles adhere to the surface of the rotating member. This may involve subjecting the electrostatic ink composition to an electric field having a field gradient of 50-400V/μm, or more, in some examples 600-900V/μm, or more.

The intermediate transfer member may be a rotating flexible member, which is in some examples heated, e.g. to a temperature of from 80 to 160° C., in some examples from 90 to 130° C., in some examples from 100 to 110° C.

The method of electrophotographic printing may be carried out so that a plurality of impressions or copies are carried out. The number of impressions or copies may be at least 1000, in some examples at least 2000, in some examples at least 3000, in some examples at least 5000. The print coverage on each print substrate in each impression may be 40% or less, in some examples 30% or less, in some examples 20% or less. An impression may be a single image of one colour formed on a print substrate. A copy may be a single image having a plurality of colours, e.g. selected from black, magenta, cyan and yellow.

The method of electrophotographic printing may be carried out so that a plurality of print substrate sheets are printed, for example 250 or more print substrate sheets, in some examples 500 or more print substrate sheets, in some examples 750 or more print substrate sheets, in some examples 1000 or more print substrate sheets. The sheets may be any suitable size or shape, e.g. of standard printing size, such as A4 or A3.

### Examples

The following illustrates examples of the methods and other aspects described herein. Thus, these Examples should not be considered as limitations of the present disclosure, but are merely in place to teach how to make examples of the present disclosure.

In the following examples, the conducive pigment is aluminum flakes having an average 8 μm diameter and 0.2 μm thickness (#12541 sourced from Carl Schlenk AG, Germany).

In the following examples, ‘Isopar’ is Isopar™ L Fluid, produced by ExxonMobil and having CAS Number 64742-48-9.

In the following examples, the resin used is Nucrel 699, available from DuPont, and A-C 5120, available from Honeywell, in a weight ratio of 4:1.

In the following examples, ‘NCD’ indicates a natural charge director made of three components: KT (natural soya lecithin in phospholipids and fatty acids), BBP (basic barium petronate i.e. a barium sulfonate salt of a 21-26 hydrocarbon alkyl, supplied by Chemtura), and GT (dodecyl benzene sulfonic acid isopropyl amine, supplied by Croda). The composition being 6.6 wt % KT, 9.8 wt % BBP and 3.6 wt % GT, balance 80% Isopar.

In the following examples, ‘SCD’ indicates a synthetic charge director, being a barium bis sulfosuccinate salt as described in US 2009/0311614 or WO2007130069. This is a strong negative charge director with strong base in the micelle core (barium phosphate) which enhances stable negative charge on ink particle. SCD is a charge director and (in the absence of a dispersant) has been found to display very low field charging (high charge partitioning).

In the following examples, Solsperse® J560 is a dispersant manufactured by Lubrizol. Formula 1 shows the molecular structure of Solsperse® J560. The molecule includes a hydrophilic head and hydrophobic tail. In this dispersant, the head is a basic group (the amine group) which may interact better with the oxide layer on the Al surface.

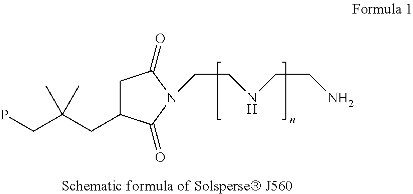

In the following examples, VCA is an Al stearate/palmitate salt added during grinding as a dispersant to improve grinding efficiency and serves mainly as a charge adjuvant for the interaction with charge director and formation of charging under electrical field application. VCA was sourced from Honeywell Riedel de-Haan, Germany.

### Example 1—Producing Pretreated Pigment

Aluminum flakes were dispersed in 5000 ml of Isopar containing 3 wt % Solsperse® J560 at a 30 wt % solids concentration. The dispersion was vigorously mixed with high shear mixer (Dispermat D-51580) for 4 hours.

### Example 2—Grinding and Working Dispersion

345 g of the product of Example 1 was ground in a grinding chamber (S1—Union Process) with 302 g of resin, 2 wt % solids VCA and various percentages (3-20 wt % solids) of Solsperse® J560. The mixture was ground at 250 RPM for 5 hours at 35° C. (the mixture during grinding contained 18 wt % non volatile solids, with the remaining liquid portion of the mixture being Isopar liquid).

After grinding, the resulting milled composition was then diluted to 2 wt % solids and charged with different amounts (mg/g on solids) of either NCD or SCD.

The following tests were performed in order to measure the inks' Particle Charge (PC) and Low Field Conductivity (LF).

Low field conductivity is the electrical conductivity of ElectroInk measured at the following conditions:
Electrical field amplitude: 5-15 V/mm
Frequency: 5-15 Hz
Temperature: 23+/−2 C

Low Field is measured by 2 electrodes spaced apart by 1.5 mm. LF is measured in Siemens units, and for an ink dispersion containing a hydrocarbon non-polar solvent charged by NCD or SCD as described herein, is at the picoSiemens level (or pmho level). Low Field Conductivity is indicative of the charged/ionized species that can be developed under low electric field and thus represents mainly the charged/ionized species that exist in the liquid phase.

High field conductivity is the maximum electrical conductivity of ElectroInk measured at the following conditions:
Electrical field pulse:
   Shape: Rectangular
   Height: 1500 V/mm
   Duration: 8 sec
   Rise time: 1 ms or less
   Ripple: 10 V/mm or less
Sampling frequency: 1000 per second
Temperature: 23+/−2 C

High field conductivity is measured in Siemens unit, and, for an ink dispersion containing a hydrocarbon non-polar solvent charged by NCD or SCD as described herein, is at the picoSiemens level (or pmho level). High field conductivity is indicative of current collected under the application of a high electric field where charged/ionized electroink particles and charged/ionized species embedded in the liquid phase are developed in electrophoretic way. Since the cell voltage is kept, any little change in the voltage due to charge collection is recorded.

Particle conductivity (PC) is the difference between the high field conductivity of an ink and the low field conductivity of the ink, typically measured in inks containing up to 2-3% NVS.

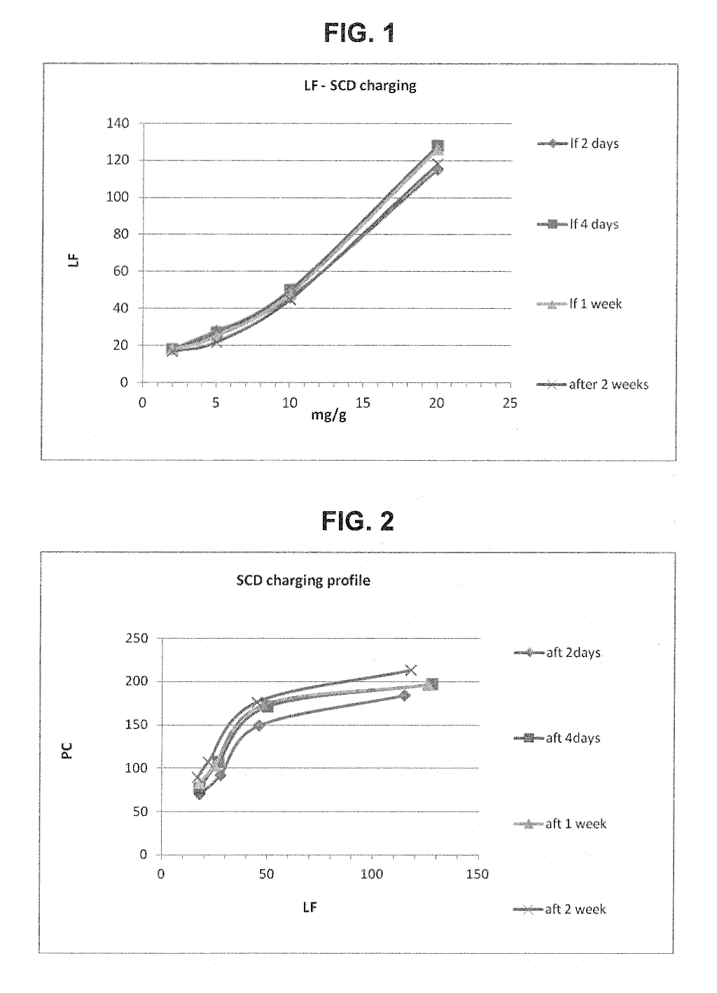

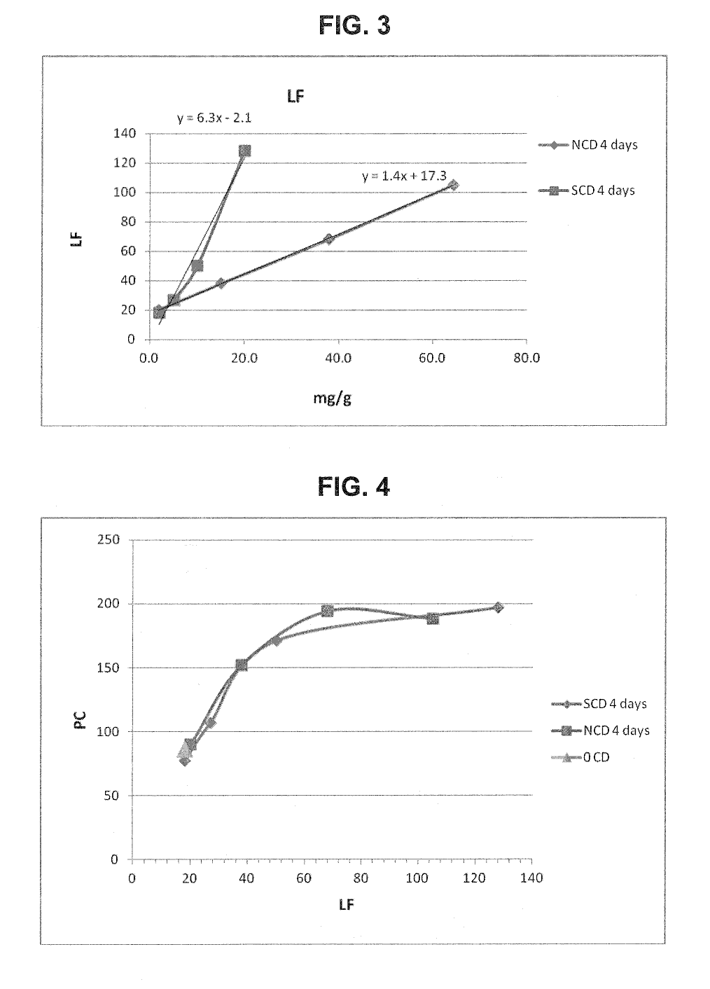

FIG. 1 shows LF increase with increased charging of SCD in the presence of J560 in the ground ink with the level of 10 wt % on solids. LF charging profile (in FIG. 1) is similar to the charging with NCD. The PC (attributed to the adsorbed charge on the ink particle) shows saturation (in FIG. 3) at ˜60 LF. LF and PC in all Figures herein are measured in pmho.

FIG. 2 shows the charging profile with PC saturates at ˜60 LF when charging with SCD in the presence of J560 in the ground ink with the level of 10 wt % on solids.

FIG. 3 shows the charging profile where the LF increase rate with SCD is higher by 4× over charging with NCD.

FIG. 4 shows the overall charging profile with PC to LF of SCD/J560 overlapping with the charging profile of NCD/J560.

FIGS. 3 and 4 allow comparison of the charging profile of silver ink (with Al pigment and 10 wt % on solids of J560) with SCD and NCD. There is a big difference in the charging profile of the LF where the LF increase rate of SCD is higher by 4× the rate of increase with NCD (FIG. 3).

While the difference of LF development varies with the amount of charge director (mg/g), there is no difference of PC development to LF. When solving PC to LF with two different charge directors, NCD or SCD, we see that the PC response to LF is the same when ink is charged with J560 as dispersant. PC is saturated at an LF of 60. Hence, the new charging system, SCD/J560, gives a similar charging profile to NCD/J56.

While the electrostatic ink composition, the method, and related aspects have been described with reference to certain examples, those skilled in the art will appreciate that various modifications, changes, omissions, and substitutions can be made without departing from the spirit of the disclosure. It is intended, therefore, that the method, compositions and related aspects be limited by the scope of the following claims. The features of any dependent claim can be combined with the features of any of the other dependent claims, and any independent claim.

1. An electrostatic ink composition comprising:
a) chargeable particles comprising a resin and a conductive pigment;
b) a charge director comprising a sulfosuccinate salt of the general formula MAn, wherein M is a metal, n is the valence of M, and A is an ion of the general formula (I):
[R¹—O—C(O)CH₂CH(SO₃)C(O)—O—R²]⁻ (I)
wherein each of R¹ and R² is an alkyl group; and
c) a dispersant being or comprising a succinimide linked to a basic group.

2. The electrostatic ink composition according to claim 1, wherein the conductive pigment comprises a metal selected from aluminium, tin, a transition metal, and alloys of any one or more thereof.

3. The electrostatic ink composition according to claim 1, wherein the conductive pigment is in the form of flakes, wherein at least some of the flakes have a thickness of from 0.01 μm to 2 μm.

4. The electrostatic ink composition according to claim 1, wherein the weight:weight ratio of the charge director to the dispersant is from 1:1 to 1:1000.

5. The electrostatic ink composition according to claim 1, wherein the weight:weight ratio of the charge director to the dispersant is from 1:10 to 1:200.

6. The electrostatic ink composition according to claim 1, wherein the basic group comprises an amine.

7. The electrostatic ink composition according to claim 1, wherein the basic group comprises an amine and the conductive pigment comprises aluminium.

8. The electrostatic ink composition according to claim 1, wherein the succinimide is a polyisobutylene succinimide and the basic group comprises an amine.

9. The electrostatic ink composition according to claim 1, further comprising a liquid carrier.

10. A method of manufacturing an electrostatic ink composition according to claim 1, comprising combining
a) a resin;
b) a conductive pigment;
c) a charge director comprising a sulfosuccinate salt of the general formula MAn, wherein M is a metal, n is the valence of M, and A is an ion of the general formula (I):
[R¹—O—C(O)CH₂CH(SO₃)C(O)—O—R²] (I)
wherein each of R¹ and R² is an alkyl group; and
d) a dispersant being or comprising a succinimide linked to a basic group, the electrostatic ink composition comprising chargeable particles comprising the resin and the conductive pigment.

11. The method of claim 10 comprising:
mixing the conductive pigment and the dispersant to form a pigment dispersion; and then
grinding the pigment dispersion with the resin, and wherein a charge director is combined with the pigment and dispersant before, during or after the grinding of the pigment dispersion with the resin to form the electrostatic ink composition.

12. A method according to claim 11, wherein the mixing the conductive pigment and dispersant to form a pigment dispersion comprises grinding the conductive pigment and dispersant together.

13. The method according to claim 11, wherein the mixing the conductive pigment and dispersant to form a pigment dispersion comprises mixing the conductive pigment, the dispersant and a liquid carrier.

14. A printed medium having printed thereon an electrostatic ink composition comprising:
a) a resin and a conductive pigment;
d) a charge director comprising a sulfosuccinate salt of the general formula MAn, wherein M is a metal, n is the valence of M, and A is an ion of the general formula (I):
[R¹—O—C(O)CH₂CH(SO₃)C(O)—O—R²]⁻ (I)
wherein each of R¹ and R² is an alkyl group; and
e) a dispersant being or comprising a succinimide linked to a basic group.

15. The printed medium according to claim 14, wherein the conductive pigment comprises a metal selected from aluminium, tin, a transition metal, and alloys of any one or more thereof.
